(19) United States
(12) Patent Application Publication
(10) Pub. No.: US 2007/0114078 A1
(43) Pub. Date: May 24, 2007

(54) Super hybrid and enhanced electric cars

(76) Inventors: Esther T. Ososanya, Washington, DC (US); Daykaker Karter, Washington, DC (US); Steven Omoijuanfo, Washington, DC (US); Oluwakayode Bamiduro, Washington, DC (US)

Correspondence Address: Dr. Esther T. Ososanya;University of the District of Columbia, Dept. of Electrical Eng., 4200 Connecticut Ave, Washington, DC, 20008, US

(21) Appl. No.: 11/241,947

(22) Filed: Nov. 9, 2005

(51) Int. Cl. B60K 1/00

(52) U.S. Cl. 180/65.1

(57) ABSTRACT

The Super Hybrid and the Enhanced Electric Car inventions modify existing designs for commercial Hybrid vehicles and Electric Cars by replacing the conventional power sources with the use of Turbine engines, which provide continuous power source. Using Turbine engines allow the reduction of multiple storage batteries in existing designs to at most two batteries. The improvements made in the Super Hybrid design have the advantages of extending the fuel consumption from an average of 60 miles to a gallon to more than 100 miles per gallon, reducing fuel emission, and reducing the cost of the multiple battery pack by about 80%. The improvements made in the Enhanced Electrical Cars have vehicle cost reduction advantages with 80% reduction in the cost of the series parallel battery pack, and longer battery life cycles.

### EXISTING HYBRID CARS

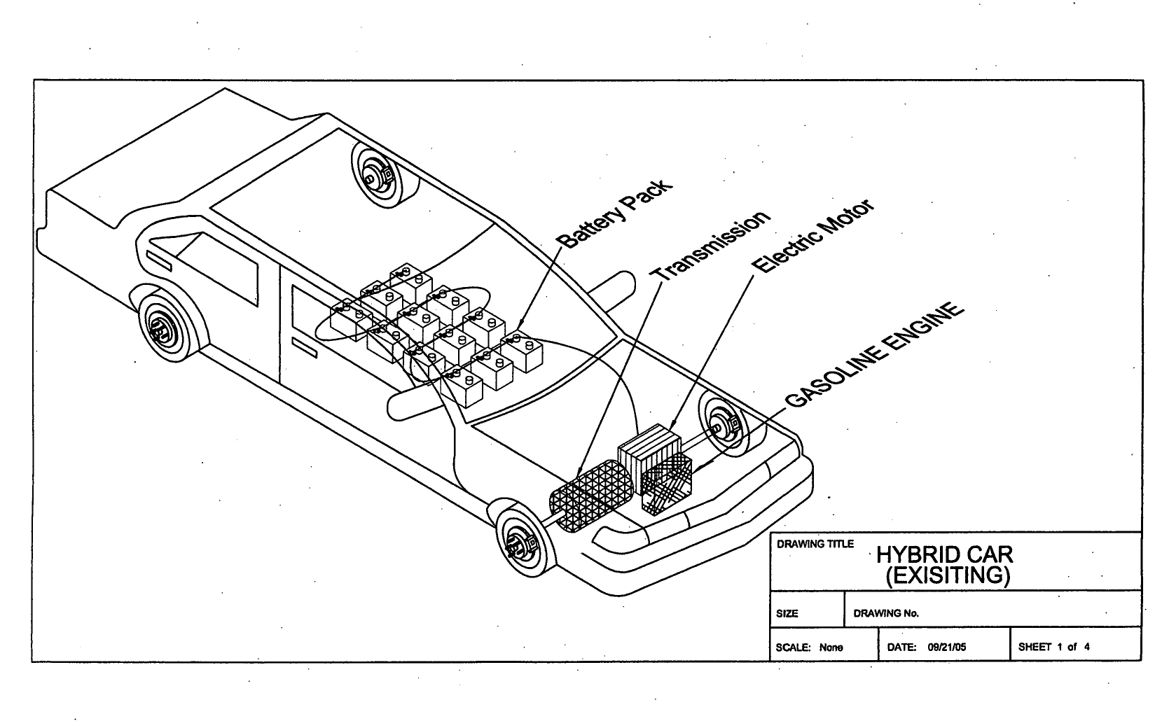

The Hybrid car shown in FIG. 1 exhibits the current features such as the following:
GASOLINE ENGINE: The purpose of a gasoline car engine is to convert gasoline into motion so that the vehicle can propel forward. Currently, this motion is created from burning of gasoline inside the engine.
TRANSMISSION: The transmission allows the gear ratio between the gasoline engine and the drive wheels to change as the car speeds up and slows down.
ELECTRIC MOTOR: The conventional electric motor drives the vehicle.
BATTERY: In a hybrid car, the series-parallel battery pack store energy for the electric motor. Unlike the gasoline in the fuel tank, which can only power the gasoline engine, the electric motor on a hybrid car can put energy into the batteries as well as draw energy from them, which preserve energy.

Conventionally, vehicles without the hybrid system consume at most 20 miles to a gallon. However, existing hybrid vehicles consume 32 to 50 miles a gallon.

### IMPROVEMENT

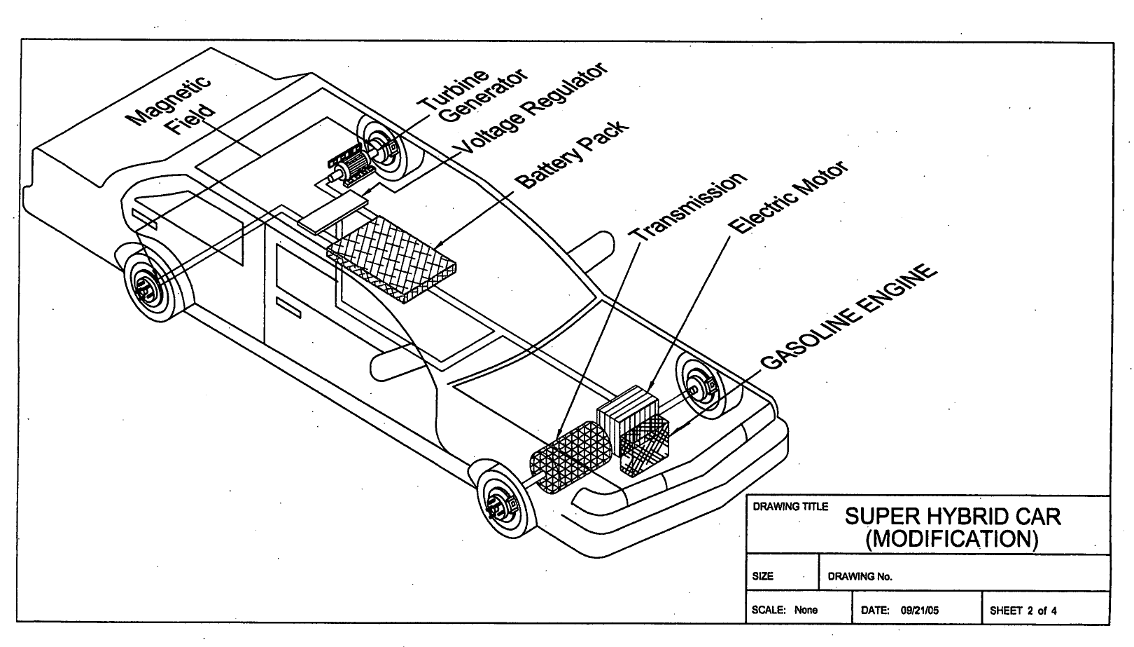

The SUPER HYBRIDS© (or ENHANCED HYBRID© CARS) proposed in this patent, FIG. 2, uses all of the above features but reduces the battery pack to just two batteries and uses a turbine generator which is attached to the wheels to create constant electricity once the vehicle is in motion. The addition of the turbine engine enables the vehicle to travel a distance of at least 150 miles to every gallon of fuel consumed. In other words, the SUPER HYBRID© stretches the vehicle's fuel consumption to 150 miles to a gallon or more. Up to four miniature turbines encapsulated can be attached to each wheel to create more electricity, DC or AC, as required. Ultimately, this reduces fuel emission, and hence is environmentally friendly. The spinning wheel spins a coil inside a magnetic field, which generates electricity.

### Existing Electric Car

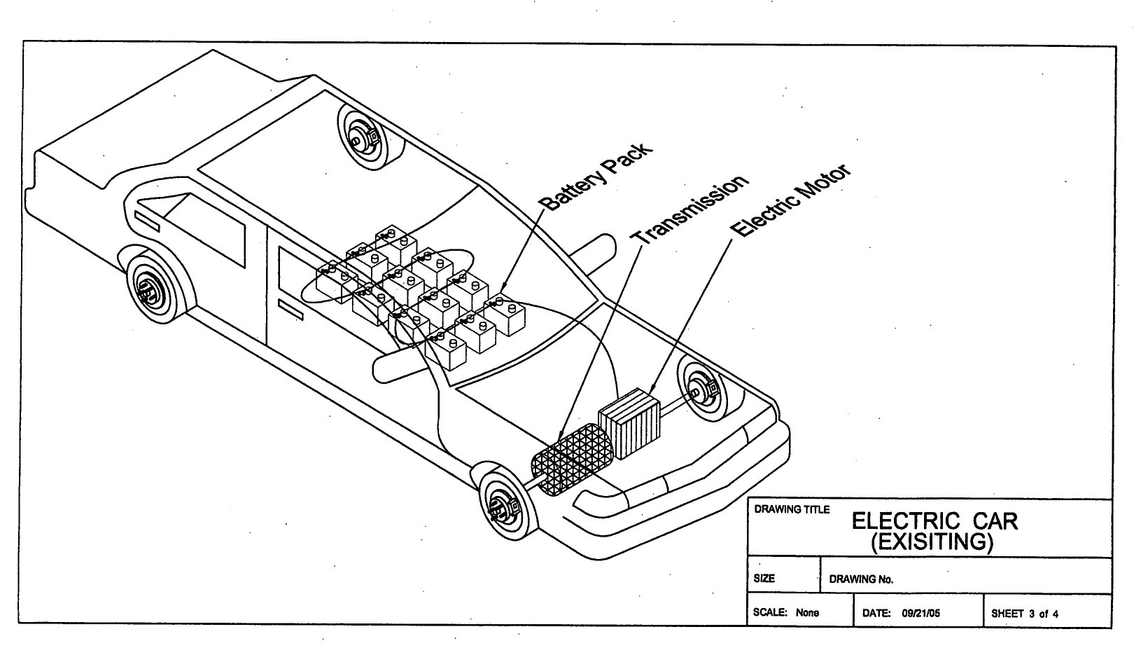

Currently, electric cars create less pollution than gasoline powered cars, so they are environmentally friendly. However, the weak link in the electric car is the battery pack, FIG. 3. Conventional battery packs have about 200 full charge/discharge cycles, slow to charge, expensive, limited in capacity (battery pack holds 12 to 15 kilowatt-hours of electricity), bulky and heavy, and have short life. The Nickel Metal Hydride (NiMH) has replaced the conventional battery pack in electric cars. NiMH batteries have the advantages of thousands of charge/discharge cycles, and up to 10 year's lifetime. However, the cost of the NiMH battery packs today is 10 to 15 times greater than lead-acid (Conventional battery packs). In other words, NiMH battery packs cost $20,000 to $30,000 (today), which cost more than the prize of average cars.

### Improvement

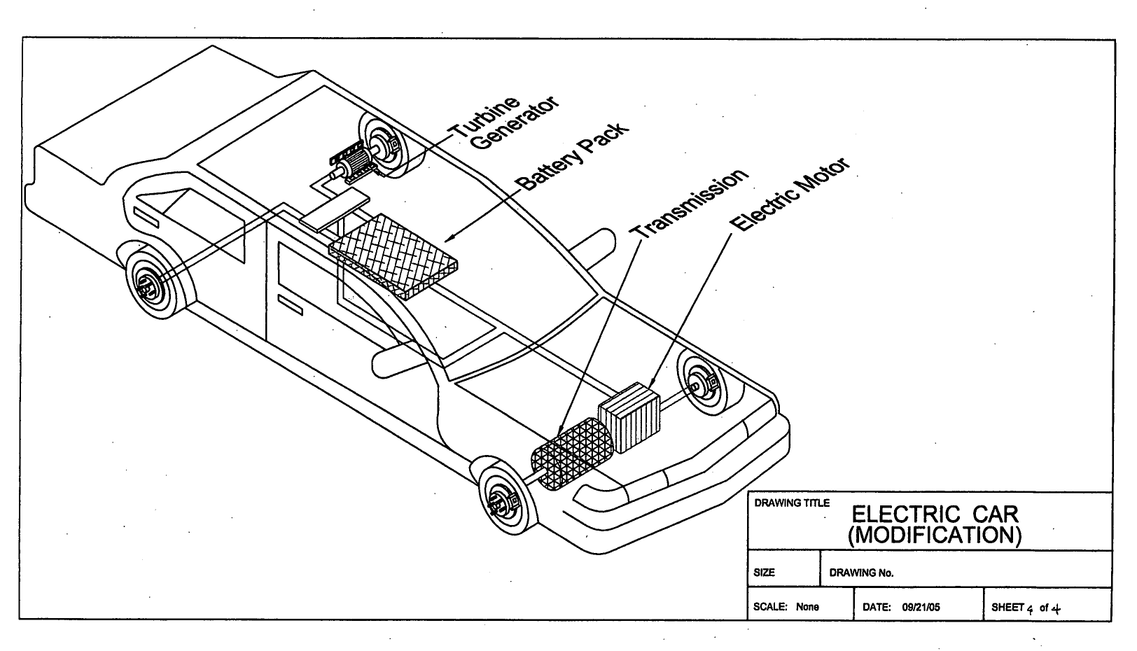

The TURBINE CAR© (or ENHANCED ELECTRIC CAR ©) proposed in this patent, FIG. 4, attach a turbine generator to the wheel to create constant electricity once the vehicle is in motion. Because of the availability of constant electricity, the battery pack is reduced to just 2 NiMH batteries, which will reduce the battery cost by about 80% or more. Up to four encapsulated miniature turbines can be installed in a vehicle for back up and/or to create more power as required. This approach can also be adapted with some modifications to power other types of vehicles, jets, boats, and trains:

The following phrases are copyrighted in this article:
SUPER HYBRID© (or ENHANCED HYBRID©)
TURBINE CAR© (or ENHANCED ELECTRIC CAR ©)
TURBINE VEHICLES©

### REFERENCES

1. How Stuff Works.com
   http://auto.howstuffworks.com/hybrid-car2.htm
2. Fundamentals of Electromagnetism
   http://www.wvic.com/how-gen-works.htm
3. Existing Hybrid and Electric Vehicles
   http://students.bath.ac.uk/en2ogmc/Parallel%20Hybrids.htm
   http://auto.howstuffworks.com/hybrid-car2.htm
4. Typical Turbine Generator module
   http://www.eere.energy.gov/windandhydro/wind_how.html?print#inside

What we claim:

1. We claim the design of Super Hybrid Vehicles using Turbine engines.

2. We claim the design of Enhanced Electric Cars using Turbine engines.
